(19) United States
(12) Patent Application Publication
(10) Pub. No.: US 2007/0088676 A1
(43) Pub. Date: Apr. 19, 2007

(54) Locating documents supporting enterprise goals

(76) Inventor: Peter D. Rail, Plano, TX (US)

Correspondence Address: FISH & RICHARDSON P.C., P.O. BOX 1022, MINNEAPOLIS, MN, 55440-1022, US

(21) Appl. No.: 11/249,551

(22) Filed: Oct. 13, 2005

(51) Int. Cl. G06F 17/30

(52) U.S. Cl. 707/3

(57) ABSTRACT

In one embodiment, a method for searching documents includes receiving a request to identify documents in an enterprise network based, at least in part, on one or more parameters. A plurality of documents are identified based, at least in part, on the one or more parameters. The plurality of documents are presented in accordance with enterprise goals.

### TECHNICAL FIELD

This invention relates to searching files and, more particularly, to locating documents supporting enterprise goals.

### BACKGROUND

Enterprises typically retain electronic documents such as intranet web pages, word-processing documents, spreadsheets, and presentations. The stored documents can be a valuable asset to the enterprise because the documents can include a wealth of institutional knowledge. Accordingly, the enterprise typically encourages employees to search through such documents to assist them in carrying out their duties. Conventionally, a search engine includes a spider (also called a “crawler” or a “bot”) that identifies existing electronic documents. After identifying documents, another program creates an index (sometimes called a “catalog”) using the identified documents. The search engine compares received request including keywords to the entries in the index and returns results to the user.

### SUMMARY

In one embodiment, a method for searching documents includes receiving a request to identify documents in an enterprise network based, at least in part, on one or more parameters. A plurality of documents are identified based, at least in part, on the one or more parameters. The plurality of documents are presented in accordance with enterprise goals.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an example document management system;

FIG. 2 illustrates an example flow diagram for locating documents using the document management system of FIG. 1; and

FIG. 3 illustrates another example flow diagram for locating documents using the document management system of FIG. 1.

Like reference symbols in the various drawings indicate like elements.

### DETAILED DESCRIPTION

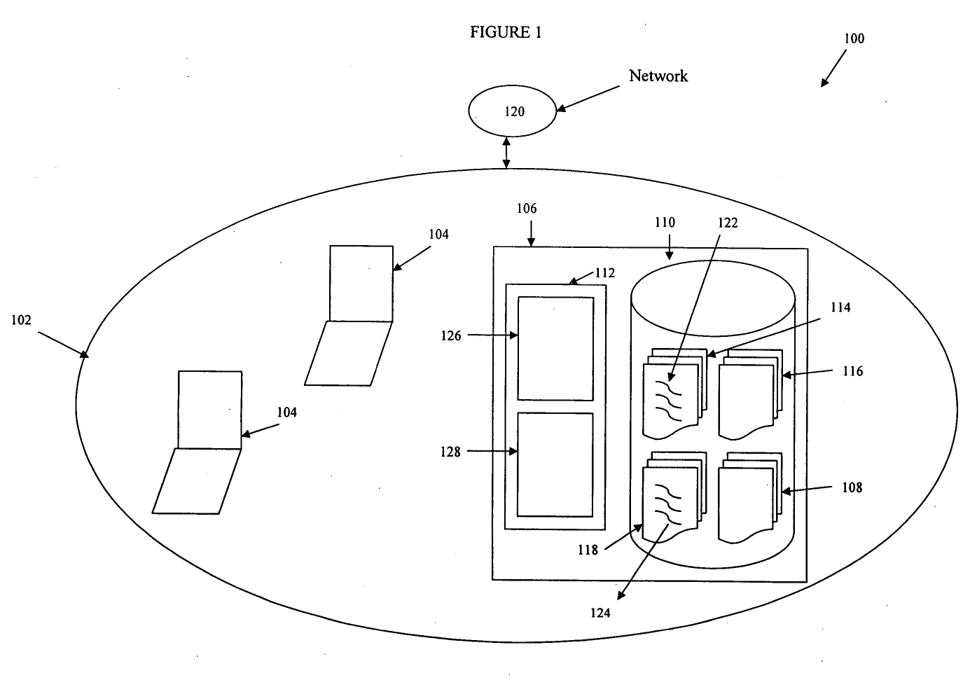

FIG. 1 illustrates a block diagram of a document management system 100. At a high level, the system 100 operates in a distributed environment comprising an enterprise network 102 including enterprise devices 104 and a document management server 106. In general, system 100 identifies documents in enterprise 102 and presents the identified documents to a user of system 100 in accordance with enterprise goals. Enterprise goals includes information that identifies or may be used to identify a goal associated with an enterprise. For example, an enterprise goal may include minimizing overhead of a particular division, increasing advertising for a particular division, decreasing assembly time of a product produced by a particular division, expanding sales of a product to a particular territory and/or type of business, maximizing products, or other goals such that the enterprise may alter and/or modify current activities to reach those goals. In summary, system 100 is operable to determine the relevancy of documents according to particular enterprise goals. As a result, system 100 may reduce or minimize the time needed to search existing documents in an enterprise that are relevant to particular goals and accurately focus on those enterprise goals that are most important. Indeed, system 100 may allow the enterprise to reduce costs and time of implementing enterprise goals by presenting the most relevant documents when searching for information associated with the enterprise goals.

The server 106 includes a memory 110 and a processor 112. The memory 110 includes documents 108, goal profiles 114, relevance profile 116, and weighting profile 118. Documents 108 include documents that may be generated and/or processed in enterprise network 102 such as word-processing documents, spreadsheets, presentations, and others. The goal profile 114 includes criteria 122 for determining the relevancy score of the document 108 for a particular enterprise goal. The relevancy score associated with the document 108 is stored in the relevance profile 116. The weighting profile 118 includes weighting factors 124 for determining the overall relevancy score of the document 108 using the relevancy scores in the relevance profile 116. Turning to the processor 112, the processor 112 includes the search engine 126 for searching documents 108 and the advice engine 128 for determining individual and overall relevancy scores of the document 108. In general, the advice engine 128 retrieves criteria 122 from the goal profiles 114 and compares them to the document 108. Based on this comparison, the advice engine 128 generates a relevancy score for the enterprise goals and stories the relevancy scores in the relevance profile 116 associated with the document 108. In response to receiving search parameters, the search engine 114 identifies documents 108 using the received parameters. The advice engine 128 then determines the overall relevancy score for each identified documents 108, which may be based on the role or security clearance of the user. In the illustrated example, the advice engine 128 retrieves weighting factors 124 from the associated weighting profile 118 and applies the weighting factors 124 to the identified documents 108. The advice engine 128 presents a list of the identified documents 108 in accordance with the relevancy score such as from highest to lowest.

The enterprise network 102 is a network associated with an enterprise. The enterprise may comprise a corporate or business entity, a government body, a non-profit institution, or any other organization with a plurality of enterprise devices 104 and the document management server 106. The enterprise may be the owner of devices 104. Of course, the enterprise may also lease devices 104 or may hire contractors or agents who are responsible for maintaining, configuring, controlling, and/or managing devices 104. In the illustrated embodiment, enterprise network 102 facilitates wireless and/or wireline communication between devices 104 and the document servers 106. Enterprise network 102 may communicate, for example, Internet Protocol (IP) packets, Frame Relay frames, Asynchronous Transfer Mode (ATM) cells, voice, video, data, and other suitable information between network addresses. In addition, while the enterprise network 102 is illustrated as a single network, the enterprise network 102 may comprise a plurality of networks. In short, the enterprise network 102 is any suitable network that includes the devices 104 and document server 106.

The devices 104 comprise devices associated with the enterprise and may include computers, servers, data storage devices, a personal computer, a workstation, network computer, kiosk, personal data assistant (PDA), one or more processors within these or other devices, or any other suitable processing device operable to generate, update or process the documents 108. Each device 104 may be associated with a group and/or an individual within the enterprise. For example, a group of devices 104 may be associated with a corporate department (e.g., accounting, marketing, research and development), a geographic or network (sub-net) region (e.g., United States, Europe), a location (e.g., building, floor in building), a customized group (e.g., “Pete's Group”), or any other suitable categorization of devices 104. In addition, groups of devices 104 may be associated with a specific document server 106. Typically, the devices 104 receive documents 108 form and/or transmit documents 108 to the document server 106.

The server 106 includes the memory 110 and the processor 112 and is generally an electronic computing device operable to receive, transmit, process, and store data associated with the system 100. For example, the server 106 may be any computer or processing device such as, for example, a blade server, general-purpose personal computer (PC), Macintosh, workstation, Unix-based computer, or any other suitable device. Generally, FIG. 1 provides merely one example of computers that may be used with the system 100. For example, although FIGURE 1 illustrates one server 106 that may be used, the system 100 can be implemented using computers other than servers, as well as a server pool. In other words, the system 100 can include computers other than general-purpose computers as well as computers without conventional operating systems. As used in this document, the term “computer” encompasses a personal or handheld computer, workstation, network computer, or any other suitable processing device. The server 106 may be adapted to execute any operating system including Linux, UNIX, Windows Server, or any other suitable operating system.

The memory 110 may include any memory or database module and may take the form of volatile or non-volatile memory including, without limitation, magnetic media, optical media, random access memory (RAM), read-only memory (ROM), removable media, or any other suitable local or remote memory component. In. this embodiment, the illustrated memory 110 includes documents 108, goal profiles 114, relevance profiles 116, and weighting profiles 118, but may also include any other appropriate data.

Documents 108 includes one or more entries or data structures used by the server 106 to store or otherwise identify information associated with enterprise goals and are accessible by the processor 112. The documents 108 are typically files that are produced and/or updated by applications running in enterprise network 102. For example, the document 108 may comprise a file created by a word processing application. In this case, the document 108 can include text, charts, images, or other graphics. The document 108 may be a memorandum, correspondence, a spreadsheet, a business plan, intranet web pages or other file that contains information associated with the enterprise. The document 108 may be stored in any suitable format such as, for example, a HyperText Transfer Protocol (HTTP) web page, an eXtensible Markup Language (XML) document, a flat file, comma separated value (CSV) file, a name-value pair file, SQL table, or others. Indeed, each document 108 may be a temporary or a persistent data structure. Documents 108 may be created, updated, or supplied by server 106, a third-party software vendor, or any appropriate user of any computer in system 100, loaded from a default profile, or received through network 120.

Each goal profile 114 defines rules, instructions, parameters, algorithms, or other directives used by the server 106 to determine a relevancy score associated with a particular enterprise goal. The goal profile 114 may be associated with one or more enterprise goals. In some examples, each goal profile 114 is associated with a single enterprise goal. In some examples, goal profiles 114 may store or define various data structures such as Java objects, text files, XML documents, comma-separated-value (CSV) files, internal variables, SQL, or one or more libraries. The goal profile 114 may comprise one table, file, or object or a plurality of tables, files, or objects stored on one computer or across a plurality of computers in any appropriate format. Moreover, goal profile 114 may be stored locally or remotely and may store any type of appropriate data. The goal profile 114 may be dynamically created by server 106, a third-party vendor, or any suitable user of server 106, loaded from a default file, or received through network 120. In general, the processor 112 retrieves criteria 122 from the goal profile 114. Criteria 122 are entries or instructions in the goal profile 114 such that the server 106 may determine how relevant a particular document 108 is to a particular enterprise goal. In some examples, the criteria 122 include parameters and directives for determining a relevancy score using the parameters. For instances, the processor 112 may compare the parameters to a specific document 108 and then determine the relevancy score for the associated enterprise goal in accordance with the directive. The criteria 122 may be based on parameters such as one or more keywords, metatags associated with the documents 108, an author of the document 108, a type of document 108, an associated division, dates, and/or any other parameter. The directives may comprise a mathematical expression involving the number of occurrences of particular parameters. In some examples, the directive instructs the processor 112 to sum the number of occurrences of the parameters to determine a relevancy score.

Relevance profiles 116 include information that identifies or is operable to identify relevancy scores of the document 108 for the enterprise goal. As mentioned above, the relevance scores may be based, at least in part, on goal profiles 114. In some examples, the relevance profile 116 stores the relevance score for each enterprise goals of the document 108. The relevance profile 116 may be associated with a single document 108 and identify a relevancy score of the document 108 for each enterprise goal. The relevance profile 116 may be associated with a single document 108 or a plurality of documents 108 or a plurality of documents 108 may be associated with a single relevance profiles 116. The relevance profiles 116 may include one or more of the following: file name, document type, relevancy score, security clearance, date determined, or other information associated with the document 108. In some embodiments, this information may be directly included in a search index that may be generated for searching documents such as documents 108. In this case, the search engine 126 (discussed below) compares search parameters to the search index to identify documents and their associated relevance score. The security clearance may indicate that users with particular roles are restricted from accessing or granted access to the associated document 108. For example, certain documents 108 may contain future business plans that only the CEO can access. The security clearance may be provided by any number of authentication techniques such as provided on Windows-based authentication or based authentication headers over HTTP or HTTPS protocols or LDAP. The relevance profile 116 may be generated and/or updated in response to an event such as generation of the associated document 108, modification of the associated document 108, selection from a user of the system 100, periodically, or other events. The relevance profile 116 may be any suitable format such as, for example, an XML document, a flat file, CSV file, a name-value pair file, SQL table, or others.

Each weighting profile 118 defines rules, instructions, parameters, algorithms, or other directives used by the server 106 to determine an overall relevancy score based, at least in part, on a plurality of enterprise goals. The weighting profile 118 may be associated with a division, a document type, all documents 108, a role of a user, and/or other aspects of system 100. A role of a user may include administrator, manager, corporate executive officer, corporate financial officer, head of a division, or other role. In some examples, each weighting profile 118 is associated with a different role. In the role example, an administrative and a CFO role may be associated with different weighting profiles 118 and, as a result, have different overall relevancy score for a particular document 108. This example illustrates that different roles may emphasize different enterprise goals. In some examples, weighting profiles 114 may store or define various data structures such as Java objects, text files, XML documents, comma-separated-value (CSV) files, internal variables, SQL, or one or more libraries. The weighting profile 118 may comprise one table, file, or object or a plurality of tables, files, or objects stored on one computer or across a plurality of computers in any appropriate format. Moreover, weighting profile 118 may be stored locally or remotely and may store any type of appropriate data. The weighting profile 118 may be dynamically created by server 106, a third-party vendor, or any suitable user of server 106, loaded from a default file, or received through network 120. In general, the processor 112 retrieves weighting factors 122 from the weighting profile 118. Weighting factors 122 are entries or instructions in the weighting profile 118 such that the server 106 may determine an overall relevancy score for an associated document 108. For example, the weighting factors 122 may include a factor for each relevancy score in the relevance profile 116. In this case, each factor may be multiplied times the associated relevancy score, and the resulting products can be summed to determine an overall relevancy score. The weighting factors 122 may comprise other suitable mathematical expressions such that server 106 may use to determine an overall relevancy score of the document 108. In some examples, the weighting factors 122 vary based on the role of a user, as mentioned above.

The server 106 also includes the processor 112. The processor 112 executes instructions and manipulates data to perform the operations of the server 106 and may be any processing or computing component such as, for example, a central processing unit (CPU), a blade, an application specific integrated circuit (ASIC), or a field-programmable gate array (FPGA). Although FIG. 1 illustrates a single processor 112 in the server 106, multiple processors 112 may be used according to particular needs and reference to the processor 112 is meant to include multiple processors 112 where applicable. In one example, the processor 112 includes the search engine 126 and the advice engine 128 but may include any other suitable processors.

The search engine 126 can include any hardware, software, and/or firmware operable to identify documents 108 based, at least in part, on one or more parameters. For example, the search engine 126 may receive one or more keywords from the device 104 and identify documents 108 based, at least in part, on the one or more keywords. The search engine 126 may receive the one or more keywords from the device 104 through user interaction with a user interface. In some instances, a list of the identified documents 108 is provided to the device 104 for display. The search parameters may include a keyword, phrases, a date, a date range, an author, a title, a document type, and/or other criteria for searching documents. In some embodiments, the search engine 126 includes a spider, a program to index identified documents 108, and a program to compare parameters to the search index. The search engine 126 may use other processes for searching documents 108.

The advice engine 128 can include any software, hardware, and/or firmware operable to determine individual and overall relevancy scores of the documents 108. Regarding individual relevancy scores, the advice engine 128 identifies a document 108, retrieves criteria 122 associated with a specific enterprise goal, and compares the criteria 122 to the identified document 108. Based, at least in part, on this comparison, the advice engine 128 determines an individual relevancy score and stores the score in the relevance profile 116 associated with the identified document 108. As to the overall score, the advice engine 128 identifies the weighting profile 118 based, at least in part, on a request and retrieves the weighting factors 124 from the weighting profile 118. The request may identify a role of a user, a date range, author of documents, or other information that may be used to identify the weighting profile 118. In connection with retrieving the weighting factors 124, the advice engine 128 retrieves the individual relevancy scores from the associated relevance profile 116 and applies the weighting factors 124 to the relevancy scores to determine the overall relevancy score.

Network 120 facilitates wireless or wireline communication between computer 110 and any other computer. Network 120 may communicate, for example, IP packets, Frame Relay frames, ATM cells, voice, video, data, and other suitable information between network addresses. Network 120 may include one or more LANs, RANs, MANs, WANs, all or a portion of the global computer network known as the Internet, and/or any other communication system or systems at one or more locations.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

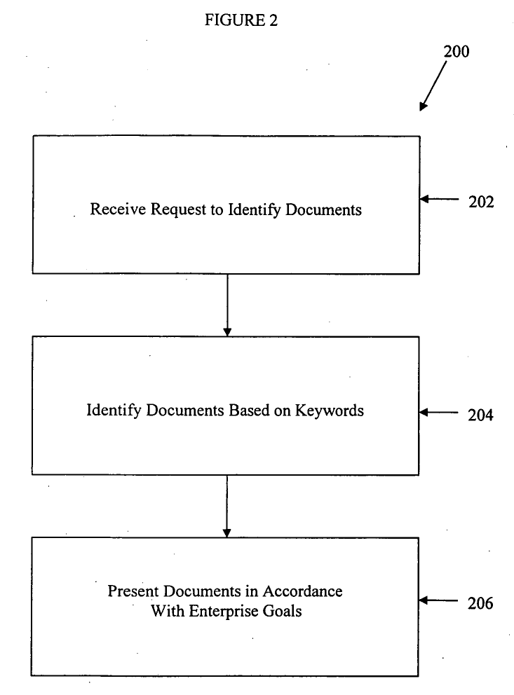

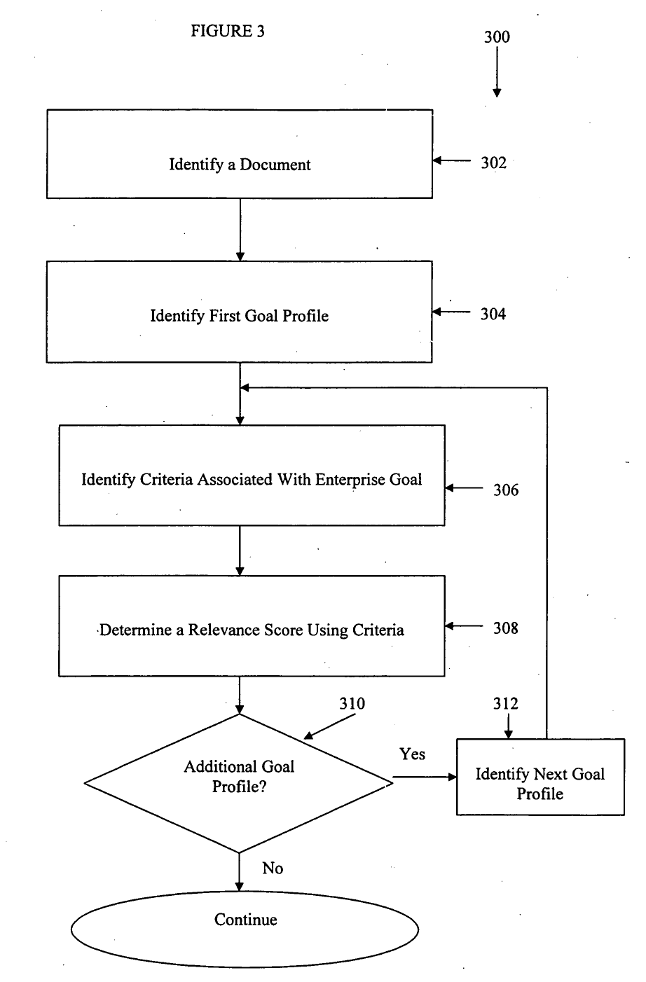

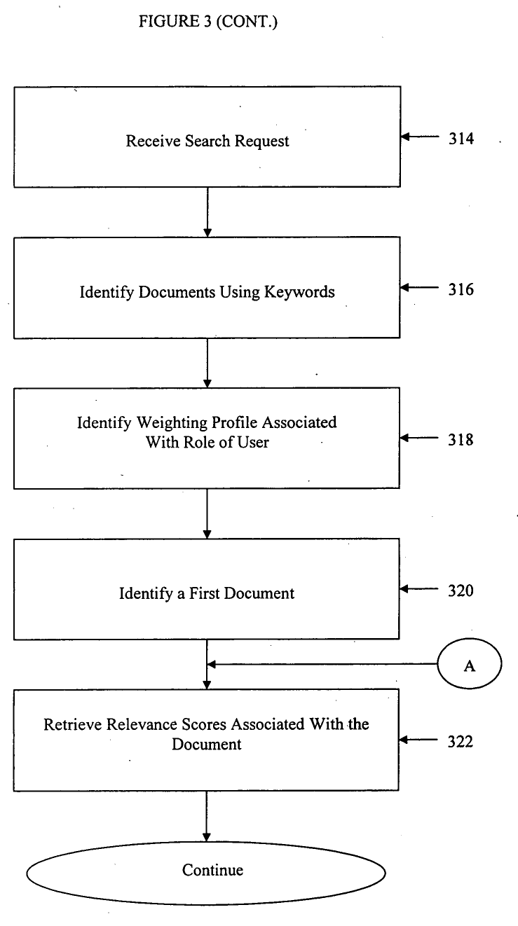

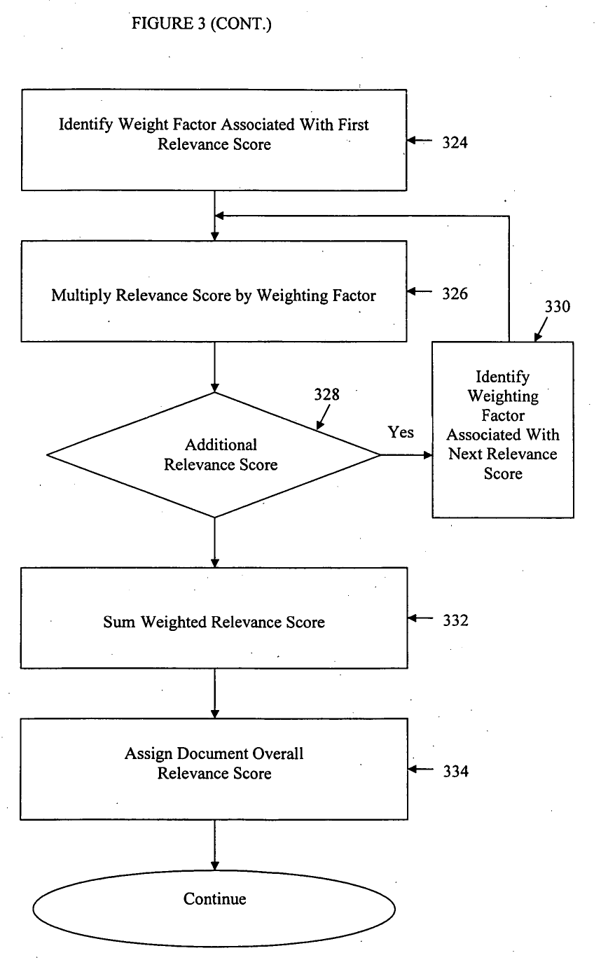

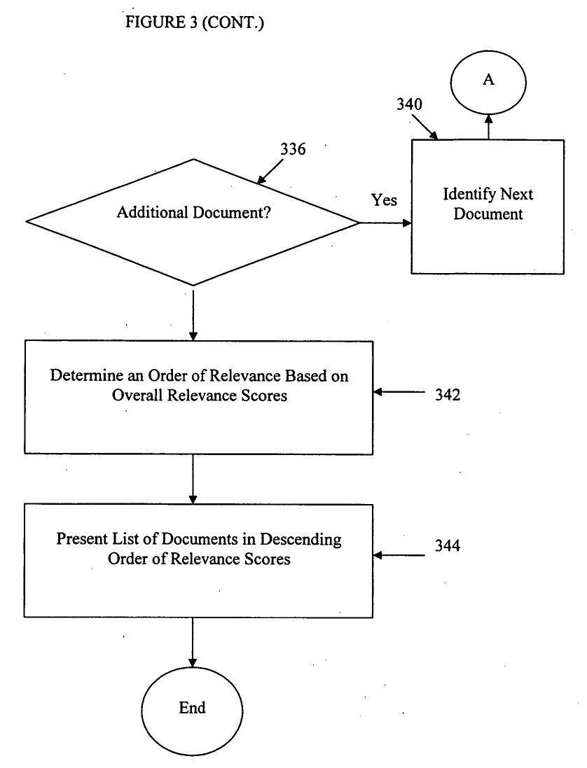

FIGS. 2 and 3 illustrate flow diagrams implementing example processes for using document management system 100 of FIG. 1 to identify relevant documents 108. Process 200 and 300 are described with respect to management system 100 of FIG. 1, but process 200 and 300 could be used by any other application or applications. Thus, many of the steps in these flowcharts may take place simultaneously and/or in different orders as shown. Further, management system 100 may execute logic implementing techniques similar to one or both of process 200 and 300 in parallel or in sequence. Management system 100 may also use processes with additional steps, fewer steps, and/or different steps, so long as the processes remain appropriate.

Referring to FIG. 2, process 200 begins at step 202 where the search engines 126 receives a request to identify documents 108 including parameters received from a user. As discussed above, the search engine 126 typically receives keywords provided by the user to identify the documents 108. At step 204, the search engine 126 identifies documents 108 based, at least in part, on the received parameters. In the keyword example, the search engine 126 may identify all documents 108 that include the keywords. Next, at step 206, the advice engine 128 presents the identified documents 108 in accordance with the enterprise goals. For example, the device engine 128 may present a list of the identified documents 108 in order of their relevance score from highest to lowest.

Referring to FIG. 3, process 300 includes two sub-processes: generating individual relevance scores for a document 108 (steps 302-312) and presenting results of a search request in accordance with enterprise goals (steps 314-340). Process 300 begins at step 302 where the advice engine 128 identifies a document 108. The advice engine 128 may identify the document 108 in response to the generation of the document 108 or any other suitable event. A step 304, the advice engine 114 identifies a first goal profile 114, and, at step 306, the advice engine 114 retrieved the criteria 122 associated with the enterprise goal. Next, the device engine 128 compares the criteria 122 to the identified document 108 to determine a relevance score for the enterprise goal. The relevance score may be stored in an associated relevance profile 116. If there are additional goal profiles 114 at decisional step 320, then, at step 312, the advice engine 128 identifies the next goal profile 114. If there are no additional goal profiles 114 at decisional step 320, then execution proceeds to step 314.

Turning to the presentation process, the search engine 126 receives a search request for documents 108. The request may include keywords and/or a role of the user. At step 316, the search engine 126 identifies documents 108 using the keywords. The advice engine 128 identifies the weighting profile 118 associated with the role of the user at step 318. Next, at step 320, the advice engine 128 identifies a first document. The advice engine 128 retrieves the individual relevance scores associated with the document 108 from an associated relevance profile 116 at step 322. At step 324, the advice engine 128 identifies a weighting factor 124 associated with the first relevance score. The advice engine multiplies the relevance score times the weighting factor 124 at step 326. If additional relevance score are available at decisional step 328, then, at step 330, the advice engine identifies the weighting factor 124 associated with the next relevance score. If there are no additional relevance score at decisional step 328, then execution proceeds to step 332. The advice engine 128 sums the weighted relevance scores to determine the overall relevance. At step 334, the advice engine 334 assigns the overall relevance score to the document 108. If additional documents are available at decisional step 336, then, at step 340, the advice engine 128 identifies the next document 108 and execution returns to step 322. If additional documents are not available at decisional step 336, then execution proceeds to step 342. The order of the relevance of the identified documents 108 is determined using the overall relevance score assigned to each document 108 at step 342. The advice engine 128 presents a list of the documents in descending order of relevance score to the user at step 344.

Although this disclosure has been described in terms of certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for searching documents, comprising:
receiving a request to identify documents in an enterprise network based, at least in part, on one or more parameters;
identifying a plurality of documents based, at least in part, on the one or more parameters; and
presenting the plurality of documents in accordance with enterprise goals.

2. The method of claim 1, further comprising:
identifying criteria associated with each enterprise goal; and
determining a relevance score of each document based, at least in part, on the criteria associated with each enterprise goal.

3. The method of claim 1, wherein determining a relevance score of each document comprises:
determining a relevance score of each document for each enterprise goal based, at least in part, on criteria associated with the enterprise goal; and
determining an overall relevance score of each document based, at least in part, on the relevance scores associated with the document.

4. The method of claim 3, further comprising:
receiving a selection by a user of one or more enterprise goals; and
wherein the overall relevance score of a document is determine based on one or more relevance scores associated with the selected enterprise goals.

5. The method of claim 3, wherein the relevance score is based, at least in part, on at least one of author, organization, campaign, or subject.

6. The method of claim 3, wherein determining an overall relevance score comprises:
identifying weighting factors associated based on the request;
applying weighting factors to the relevance scores associated with each document; and
determining the overall relevance score of each document based, at least in part, on the weighted relevance scores.

7. The method of claim 6, wherein presenting the plurality of documents in accordance with the relevance score comprises presenting a list of the plurality of documents in descending order of overall relevance score.

8. The method of claim 6, wherein the weighting factors are based on a role of a user.

9. The method of claim 1, further comprising:
determining a relevance score of each document in accordance with enterprise goals; and
presenting the plurality of documents in accordance with the relevance score.

10. An article comprising a machine-readable medium storing instructions for causing data processing apparatus to perform operations comprising:
receiving a request to identify documents in an enterprise network based, at least in part, on one or more parameters;
identifying a plurality of documents based, at least in part, on the one or more parameters; and
presenting the plurality of documents in accordance with enterprise goals.

11. The article of claim 10, further performing operations comprising:
identifying criteria associated with each enterprise goal; and
determining a relevance score of each document based, at least in part, on the criteria associated with each enterprise goal.

12. The article of claim 10, wherein determining a relevance score of each document comprises:
determining a relevance score of each document for each enterprise goal based, at least in part, on criteria associated with the enterprise goal; and
determining an overall relevance score of each document based, at least in part, on the relevance scores associated with the document.

13. The article of claim 12, further performing operations comprising:
receiving a selection by a user of one or more enterprise goals; and
wherein the overall relevance score of a document is determine based on one or more relevance scores associated with the selected enterprise goals.

14. The article of claim 12, wherein the relevance score is based, at least in part, on at least one of author, organization, campaign, or subject.

15. The article of claim 12, wherein determining an overall relevance score comprises:
identifying weighting factors associated based on the request;
applying weighting factors to the relevance scores associated with each document; and
determining the overall relevance score of each document based, at least in part, on the weighted relevance scores.

16. The article of claim 15, wherein presenting the plurality of documents in accordance with the relevance score comprises presenting a list of the plurality of documents in descending order of overall relevance score.

17. The article of claim 15, wherein the weighting factors are based on a role of a user.

18. The article of claim 10, further performing operations comprising:
determining a relevance score of each document in accordance with enterprise goals; and
presenting the plurality of documents in accordance with the relevance score.

19. A system, comprising:
memory storing documents; and
one or more processors operable to:
receive a request to identify documents in an enterprise network based, at least in part, on one or more parameters;
identify a plurality of documents based, at least in part, on the one or more parameters; and
present the plurality of documents in accordance with enterprise goals.

20. The system of claim 19, the processors further operable to:
identify criteria associated with each enterprise goal; and
determine a relevance score of each document based, at least in part, on the criteria associated with each enterprise goal.

21. The system of claim 19, wherein the processors operable to determine a relevance score of each document comprises the processors operable to:
determine a relevance score of each document for each enterprise goal based, at least in part, on criteria associated with the enterprise goal; and
determine an overall relevance score of each document based, at least in part, on the relevance scores associated with the document.

22. The system of claim 21, the processors further operable to:
receive a selection by a user of one or more enterprise goals; and
wherein the overall relevance score of a document is determine based on one or more relevance scores associated with the selected enterprise goals.

23. The system of claim 21, wherein the relevance score is based, at least in part, on at least one of author, organization, campaign, or subject.

24. The system of claim 21, wherein the processors operable to determine an overall relevance score comprises the processors operable to:
identify weighting factors associated based on the request;
apply weighting factors to the relevance scores associated with each document; and
determine the overall relevance score of each document based, at least in part, on the weighted relevance scores.

25. The system of claim 24, wherein the processors operable to present the plurality of documents in accordance with the relevance score comprises the processors operable to present a list of the plurality of documents in descending order of overall relevance score.

26. The system of claim 24, wherein the weighting factors are based on a role of a user.

27. The system of claim 19, the processors further operable to:
determine a relevance score of each document in accordance with enterprise goals; and
present the plurality of documents in accordance with the relevance score.
